(19) United States
(12) Patent Application Publication
(10) Pub. No.: US 2009/0144743 A1
(43) Pub. Date: Jun. 4, 2009

(54) Mailbox Configuration Mechanism

(75) Inventor: Brandon Wolslegel, Black Diamond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/946,884

(22) Filed: Nov. 29, 2007

(51) Int. Cl. G06F 9/46; G06F 7/00

(52) U.S. Cl. 718/105; 707/101; 707/E17.044; 707/E17.005

(57) ABSTRACT

An email configuration system may use a topology database to determine if a change request results in a valid configuration. The topology database may contain a definition of an enterprise email system, including forests, servers, and individual mailboxes. If a valid configuration is found, a change request may be scheduled and implemented. The email configuration system may store the change request so that a change may be undone at a later time. Changes may be implemented to the enterprise mail system by changing the topology definition and running an analysis of the current topology and a desired topology.

### BACKGROUND

Mail servers may host mailboxes and provide other email services to clients. A client, which may be operating on any type of device such as a handheld device or a desktop computer, may access various email services from a mail server over a network.

Some organizations may have two or more mail servers, and large enterprises may have two or more forests of mail servers, with each forest having several mail servers. In some very large installations, several hundred mail servers may be used to provide email services to tens or hundreds of thousands of users.

### SUMMARY

An email configuration system may use a topology database to determine if a change request results in a valid configuration. The topology database may contain a definition of an enterprise email system, including forests, servers, and individual mailboxes. If a valid configuration is found, a change request may be scheduled and implemented. The email configuration system may store the change request so that a change may be undone at a later time. Changes may be implemented to the enterprise mail system by changing the topology definition and running an analysis of the current topology and a desired topology.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with an email configuration system.

FIG. 2 is a diagram illustration of an embodiment showing email configuration system components and some interactions between the components.

FIG. 3 is a flowchart illustration of an embodiment showing a method for configuring an email system.

### DETAILED DESCRIPTION

An email configuration system may use a topology database to determine if a change request results in a valid configuration as well as to generate change requests for current configurations that do not comply with the topology database. Such a system may implement a single change to a complex email system or may be able to perform large numbers of operations by changing some topology parameters.

A topology database may include various descriptors for a forest of mail servers, individual mail servers, as well as individual mailboxes hosed by one of the mail servers. The descriptors may include various performance or configuration limitations as well as various rules that may describe how a component may be configured or operated.

The topology database may be populated by a topology tracker that may crawl a network, discover new forests, servers, or other components, and add the components to the topology database.

The email configuration system may have a scheduler that may be able to receive several change requests, analyze the change requests, and implement various steps to fulfill the change requests. The scheduler may be able to implement a change at a predetermined time or when the servers, network, or other conditions are favorable for the steps. In many embodiments, the scheduler may log each step and may also be capable of undoing the steps at a later time or if an error was encountered during implementation.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

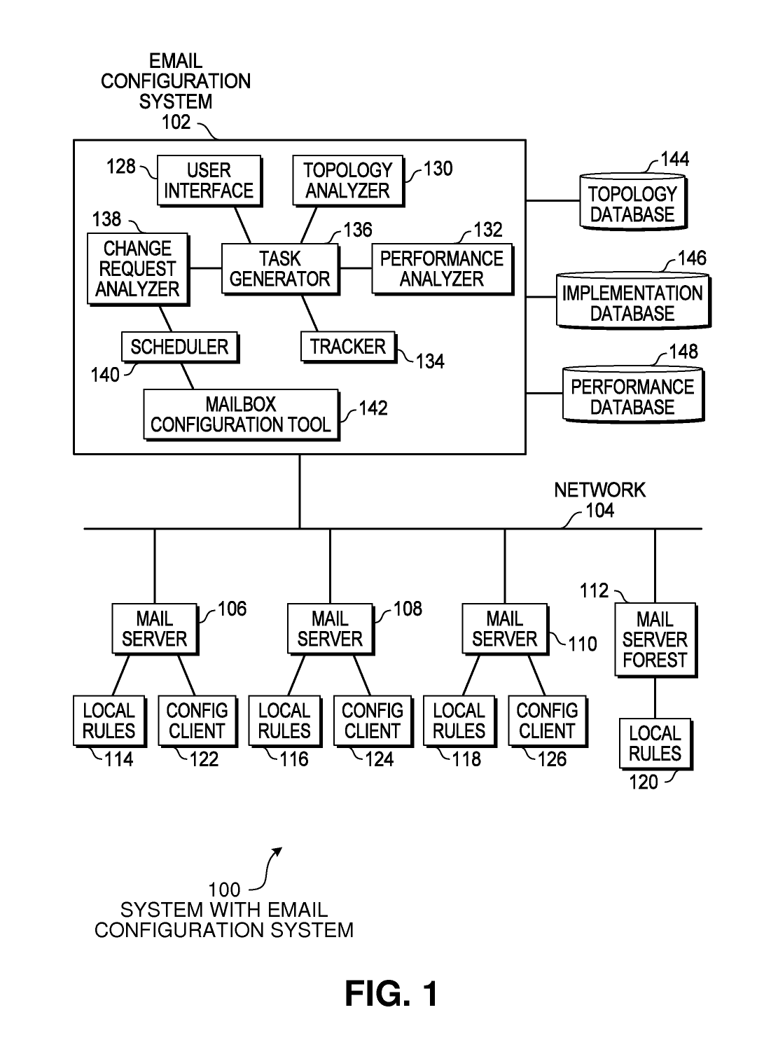

FIG. 1 is a diagram of an embodiment 100 showing a system with an email configuration system. Embodiment 100 is an example of a system that may perform many email configuration tasks across several email servers and forests of email servers.

The diagram of FIG. 1 illustrates functional components of a system. The components are illustrated as functional components and may not correspond to a specific hardware, software, or other component. The illustrated components were selected to highlight and describe various functional aspects of a system. Different embodiments may use various hardware and software architectures to achieve similar functions.

In some cases, the component may be a hardware component, a software component, or a combination of hardware and software. Some of the components may be application level software, while other components may be operating system level components, hardware devices, or other elements. In some cases, the connection of one component to another may be a close connection where two or more components are operating on a single hardware platform. In other cases, the connections may be made over network connections spanning long distances.

An email configuration system 102 may be connected to a network 104 and may perform various functions across several mail servers 106, 108, and 110 and across one or more mail server forests 112. The functions may include setting up mailboxes, moving mailboxes, load balancing across multiple mail servers, migrating mailboxes, upgrading mail servers, and other functions.

The email configuration system 102 may use various rules or other definitions associated with individual mail forests, mail servers, and mailboxes to evaluate a potential change prior to execution, as well as use changes to the rules or definitions to affect changes to the mail services.

Each mail server 106, 108, and 110 may have local rules 114, 116, and 118. Similarly, a mail server forest 112 may have a set of local rules 120. The rules may be any type of definition that may define characteristics of a forest, server, or mailbox that the email configuration system 102 may apply. For example, a mail forest may have a set of definitions or rules that specify the overall storage capacity of the forest or may define specific types of mailboxes that may be hosted within the forest. In another example, a mail server may have rules that define a maximum number and types of mailboxes that may be hosted by the specific server. Some individual mailboxes may also be configured with a specific set of rules.

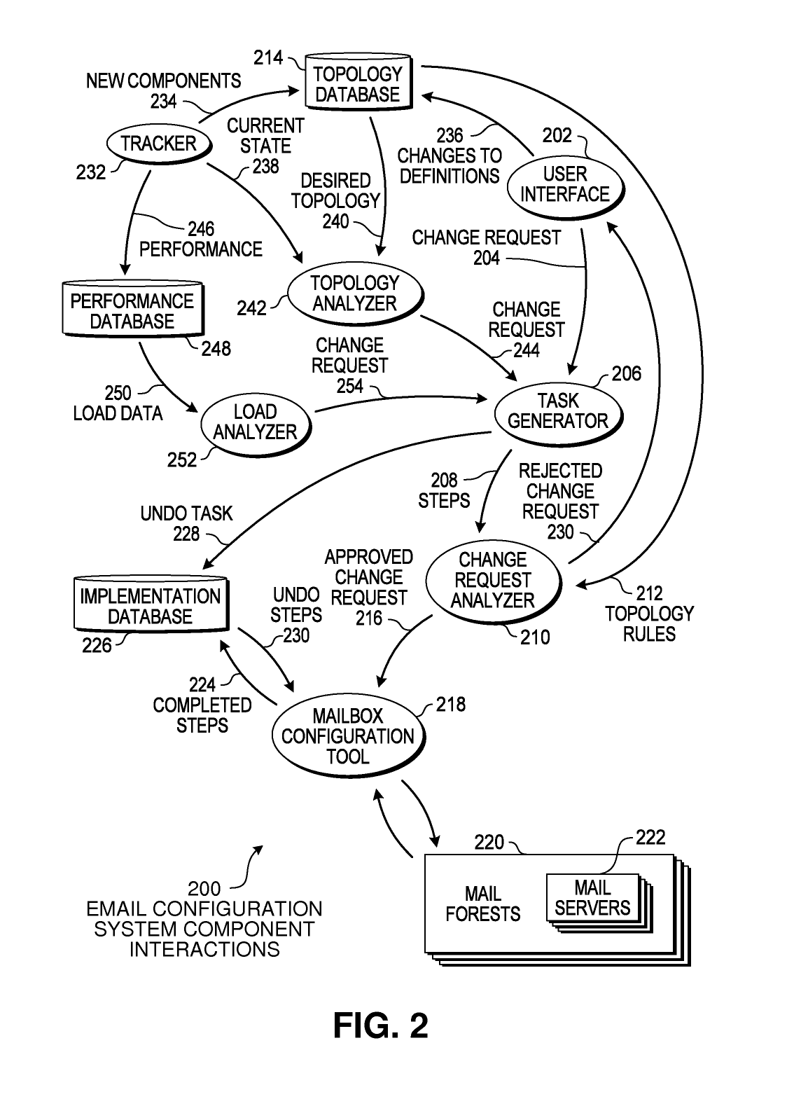

The various rules may be gathered into a topology database 144 that may be used by the email configuration system 102 to generate change requests as well as validate change requests that may be received from different sources, including user input. Some examples of how such rules may be used are illustrated in the discussion of FIG. 2 of this specification.

The email configuration system 102 may send commands to the various mail servers 106, 108, and 110 from time to time. The commands may be executed directly by the respective mail server. In some embodiments, a configuration client 122, 124, and 126 may be operable on a device hosting the respective mail server. A configuration client may be a software or hardware component that serves as an interface between the email configuration system 102 and the respective mail server.

The configuration client may be an add-on component, daemon, service, or other interface that may receive commands from the email configuration system 102 and cause the respective mail server to perform an action. The configuration client may also serve as a data collection agent and may monitor performance of a mail server, perform queries against a mail server, and communicate the results to the email configuration system 102 for storage in a topology database 144 or a performance database 148.

In some embodiments, the functionality of a configuration client may be inherent to or built into a mail server. In other embodiments, a configuration client may be installed to enable the email configuration system 102 to operate with mail servers from different vendors, different types of mail servers, or for older mail servers that may not have the functionality of a configuration client built into the mail server.

The email configuration system 102 may be used to monitor and configure multiple email servers. In some cases, the email servers may be collocated while in other cases, the email servers may be located far apart. For example, a business with locations in different cities or countries may have one or more email servers located in each city or country. In another example, separate mail servers may be used within each building on a company campus. Some enterprises may configure mail servers or forests of mail servers to provide messaging services for specific departments or divisions within the enterprise.

In some embodiments, the network 104 may be a local area network when the mail servers 106, 108, and 110 are collocated with the email configuration system 102. In other embodiments, the network 104 may be a wide area network and portions of the network 104 may include the Internet when one or more of the mail servers 106, 108, 110 or the mail server forest 112 are located remotely. In some cases, the email configuration system 102 may be located remotely from the various mail servers and forests.

The email configuration system 102 may be made up of various functional elements.

A user interface 128 may be used to enter change requests, gather status information, set or change various rules or definitions for various forests, servers, or mailboxes, as well as other functions. In some cases, the user interface 128 may be a physical display with input devices such as a pointer device and a keyboard. In other cases, the user interface 128 may be a web browser interface that may be accessed using a browser client attached to the network 104. Other embodiments may have different mechanisms for providing a user interface 128.

A topology analyzer 130 may analyze data in the topology database 144 to determine if the current actual topology agrees with rules or other descriptors that define the desired topology of the mail forests, servers, and mailboxes. If a discrepancy is found between the current actual topology and the desired topology, the topology analyzer 130 may generate one or more change requests.

The topology analyzer 130 may be one method by which large or complex changes may be implemented without a relatively large amount of input from a user. For example, an administrator or other use may redefine a rule for the mail server 106 that reduces the number of allowable mailboxes on the mail server 106 to zero. The topology analyzer 130 may detect that the desired topology of the mail server 106 is inconsistent with the current state, which may be that several hundred mailboxes are currently hosted on the mail server 106, for example.

In the example, the topology analyzer 130 may generate one or more change requests that may rectify the discrepancy between the desired topology and the current topology. For example, the topology analyzer 130 may generate change requests to move some mailboxes to mail server 108 and other mailboxes to mail server 110. The change requests may comply with a rule, for example, that balances the number of mailboxes across the available mail servers.

In the example, a single rule change may be used to generate a large number of changes. A topology definition may include rules or other descriptors of how various mail system components behave or relate to other components. By changing portions of the rules or descriptors, the email configuration system 102 may generate and execute change requests to comply with a desired configuration.

In some embodiments, performance related rules and performance data may be used to affect changes to the mail system configuration. For example, a performance analyzer 132 may analyze historical performance data from a performance database 148 to determine if, for example, loads are balanced between two or more mail servers. If one mail server has a large amount of activity suffers performance drops, the performance analyzer 132 may generate change requests to move some of the more active mailboxes hosted on the mail server to a different mail server with less activity. In other examples, the performance analyzer 132 may detect that a mail server is nearing its storage capacity and may cause one or more larger mailboxes to be moved to a mail server with more storage capacity.

When a change request is generated, a task generator 136 may generate specific tasks and sequences of tasks that may be executed in order to perform the change request. For example, a user interface 128 may be used to generate a change request to move a mailbox from mail server 106 to the mail server forest 112. The task generator 136 may generate a sequence of tasks that may include creating a mailbox in the mail server forest 112, transferring the contents of the current mailbox to the new mailbox, removing the old mailbox, and changing routing information for the mailbox. In some embodiments, a change request may contain a definition of each task, while in other embodiments, a change request may be used to generate a definition of each task by the task generator 136.

A change request analyzer 138 may analyze the change request to determine if the change request complies with the desired topology of the mail system. The change request analyzer 138 may use the desired topology as defined within the topology database 144 to determine if the change request is valid. If the change request may violate the desired topology, the change request may be displayed on the user interface 128 or handled in some fashion as an exception.

In some embodiments, the change request analyzer 138 may determine a proposed final state from a change request and evaluate the proposed final state against the topology database 144. In other embodiments, each task that may be performed may be evaluated to determine if any individual task may violate the desired topology.

A scheduler 140 may schedule validated change requests to be performed by a mailbox configuration tool 142. In many cases, mailboxes may have periods of high usage, such as during a workday or in the evenings, and mailboxes may have periods of low usage, such as during nighttime or on weekends. The scheduler 140 may be capable of queuing tasks to be performed during such slow periods.

In some cases, a change request may have operations that may be performed over various times. For example, a user's email address may be changed from one address to another. The scheduler may create a new email address for the user's mailbox immediately, but may have a task that disables the user's old email address after a period of time, such as 30 days or some other designated time.

The scheduler 140 may be capable of maintaining a queue of tasks to be performed and may be able to adjust the tasks performed based on the completion or performance of tasks being executed. For example, the scheduler 140 may have a large number of tasks associated with moving a large number of mailboxes from one mail server to another. Such migration may consume a large amount of network bandwidth and may interfere with backup operations on the mail servers. In such a case, the scheduler 140 may be able to detect that a backup operation is underway on a particular server and may refrain from sending tasks to the server until the backup is complete. Similarly, the scheduler 140 may be able to withhold some tasks when the network bandwidth is becoming saturated.

In some cases, the scheduler 140 may be able to perform a portion of a queue of tasks during a period of low activity, such as overnight, but may pause tasks in the morning and resume the queue of tasks again at night. Such a case may avoid performing tasks when those tasks may cause performance degradation for mailbox users during normal periods of activity.

The mailbox configuration tool 142 may serve as the interface to various mail system components. The mailbox configuration tool 142 may send various commands to mail servers or to configuration clients for mail servers to cause changes to the mail servers. In some embodiments, the mailbox configuration tool 142 may also be used as an interface to collect data from mail servers.

As tasks are executed, the tasks may be saved in an implementation database 146. The implementation database 146 may be a central repository or log for actions performed by the email configuration system 102. In some cases, the implementation database 146 may be used to store task data that may be used to undo one or more actions taken on the mail system. For example, a list of tasks may be stored when a mailbox is moved from one mail server to another. At a later time, an administrator may elect to undo the action. The implementation database 146 may be used to perform the reverse sequence to undo the mailbox move.

The implementation database 146 may include information that may be used for auditing and tracking changes to mailboxes, as well as other historical analysis. In some embodiments, an administrator may be able to perform changes to an individual mailbox or mail server without using the email configuration system 102. For example, an administrator may be able to send commands to the mail server 106 to establish a new mailbox or to transfer the mailbox to mail server 108. In such embodiments, the implementation database 146 may or may not be able to capture the individual tasks used to perform such a task and may or may not be used to undo the task.

The email configuration system 102 may have a tracker 134 that may discover new topology and configuration information about a mail system and collect performance information about the mail system. A mail system, as used in this specification, may include the various mail components that may be monitored and configured by the email configuration system 102. Such components include mail forests, mail servers, mailboxes, or any other component that may be used to send, receive, store, and manipulate messages including email.

The tracker 134 may be capable of walking the network 104 and discovering the various mail server forests, mail servers, and mailboxes on the servers. In many cases, the tracker 134 may be capable of discovering rules associated with various mail system components. When the tracker 134 discovers a new component, the component definition may be added to the topology database 144.

In many embodiments, the tracker 134 may periodically monitor or check various mail system components to determine if changes to the topology or configuration have changed. Changes to the topology may include various performance or other parameters such as the amount of storage space available on a mail server, the bandwidth of a mail server's network connection, changes to the hardware or software of a mail server, or other such changes.

Changes to the topology may include changes to the rules associated with each mail server and each mailbox on the server. In some cases, the topology changes may also include rules associated with a forest of mail servers. The rules may be changed by modifying the local rules from an interface on the mail server. The tracker 134 may check the local rules and compare them to the rules stored for the component in the topology database 144 to determine if the rule has been modified. In some embodiments, the user interface 128 may be used to modify rules associated with individual mail server forests, mail servers, or mailboxes. In such a case, the topology database 144 may be modified by the email configuration system 102 in parallel with changing the local rules on a mail system component.

The tracker 134 may periodically check if a configuration of a mail system component has changed. A configuration parameter may relate to the presence and configuration of mailboxes on a mail server. For example, a tracker 134 may detect that several mailboxes have been added to a mail server. Such a configuration change may be used to trigger a load balancing analysis that may transfer some of the newly created mailboxes to another server that may have a lighter load.

FIG. 2 is a flow diagram of an embodiment 200 showing various functional components of an email configuration system. The functional components of embodiment 200 were selected to illustrate the operational characteristics of an email configuration system. Other embodiments may have different architectures and may combine or divide various functional components in different manners, including performing two or more operations in parallel or other operations serially. Other embodiments may use different nomenclature or terminology to describe similar functional characteristics.

Embodiment 200 illustrates various functional elements of an email configuration system and information that may be passed between the elements.

A user interface 202 may be used to generate a change request 204. In many embodiments, the user interface 202 may be a web based graphical user interface. Some embodiments may have an application user interface that may also be used. Other embodiments may use a scripting or command line interface.

When a graphical user interface is used, a portion of the topology of the email system may be displayed. For example, a forest of email servers may be selected and various status indicators may be shown. In such a graphical user interface, an administrator may be able to select an action to be performed from an input device such as a pull down menu or select a function using a button or other input device. An action may be, for example, create a mailbox. The user may use the displayed topology of the email system to select a specific mail server on which to create the mailbox. Such an example is merely illustrative of one manner in which a graphical user interface may be used to create a change request 204.

The change request 204 may be any type of modification of the email system. In some cases, a change request 204 may make a change to a single mailbox, such as create, edit, move, delete, deactivate, activate, backup, restore, or other operation that affects an individual mailbox. In other cases, a change request 204 may make changes to a mail server, such as setting various rules for mail server behavior, which may include setting the maximum number of mailboxes, setting the storage parameters for mailboxes on the mail server, or defining scripts or other actions that may be performed by the mail server when certain actions occur.

Some change requests directed at a mail server may include adding a new mail server to a forest and defining how the new mail server may share in load balancing or other functions. Some change requests may establish relationships between mail servers or forests of mail servers, as well as split one forest into two or join two forests together.

The examples of change requests is not meant to be limiting but are merely examples of possible types of actions that may be performed through individual change requests.

The change request 204 may be passed to a task generator 206 that may generate a set of specific steps 208 that specifically define the change request. In some embodiments, a change request may be defined with a few parameters and the task generator 206 may convert the parameters and type of change request into a detailed list of commands or functions that may be executed to accomplish the change request. In some embodiments, a change request 204 may include such a detailed list of commands.

In some embodiments, the steps 208 may be commands or communications that may be sent to individual mail servers to accomplish a change request. In some cases, two or more mail servers may receive commands. For example, when moving a mailbox from one server to another, a set of commands may include messages to the first server to establish a new mailbox, messages to the second server to transfer the existing mailbox contents, and messages to a router device to forward further mail messages to the new server. In such an example, some of the tasks may be sequential in nature and depend on the completion of a previous task. Some tasks may be parallel and may be executed at the same time as other tasks.

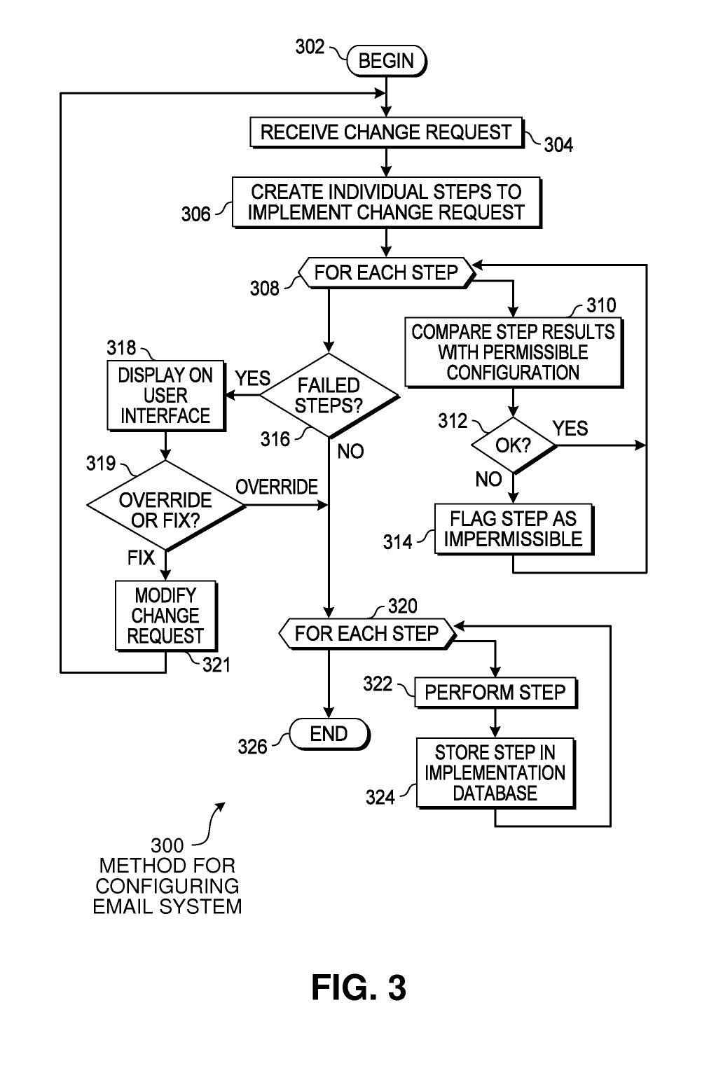

A change request analyzer 210 may analyze the change request to determine if the change request conforms to the topology rules 212 from the topology database 214. In the example in embodiment 300 shown in FIG. 3 later in this specification, the change request may be analyzed by analyzing the configuration of each step of a change request to ensure that each step results in a valid configuration.

In other embodiments, the change request may be analyzed by determining a proposed final state of a change request. The proposed final state is a state of the email system that would occur if the change request were to be completed. The proposed final state may be evaluated against the topology rules 212 to determine if the change request results in a valid state.

The topology rules may use any type of definition, nomenclature, or heuristic to define how various components of an email system are to behave or limits on how various components may operate.

The change request analyzer 210 may generate an approved change request 216 if the change request passes the validity check. The approved change request 216 may be used by the mailbox configuration tool 218 to communicate with various mail forests 220 and mail servers 222 within those forests. If the change request analyzer 210 rejects the steps 208, a rejected change request 230 may be returned to the user interface 202 for disposition.

In some embodiments, various mail servers or forest controllers may have a client application or service that operates on the host for a mail server or forest controller. The client application may be adapted to receive commands from the mailbox configuration tool 218 and translate the commands into actions performed by a particular mail server or forest controller.

When the mailbox configuration tool 218 completes a step, the completed step 224 may be stored in an implementation database 226. The implementation database 226 may be used in some embodiments to process an undo task 228. The undo task 228 may reference a previous sequence of steps in the implementation database 226 and transfer the undo steps 230 to the mailbox configuration tool 218. The undo steps 230 may be used to perform a sequence of steps to undo a previously executed set of steps.

Other mechanisms may be used to generate change requests. Data provided from a tracker 232 may be used in at least three different manners to automatically generate change requests.

A tracker 232 may be a function that gathers information about a mail system. In one role, the tracker 232 may crawl a network, discover mail servers, forests, or mailboxes. Once discovered, the tracker 232 may gather various performance parameters, configuration information, and any rules or other definitions of the component behavior. Such information about new components 234 may be stored in the topology database 214.

In another role, the tracker 232 may collect information relating to a current state 238 of various known components. For example, a current state 238 may include the number of mailboxes and the total storage used by the mailboxes on a particular mail server. A topology analyzer 242 may compare the current state 238 to the desired topology 240 as defined in the topology database 214 to generate a change request 244.

In many cases, a user interface 202 may be used to generate changes to definitions 236 regarding the topology in order to generate the change request 244. For example, an administrator may wish to decommission a mail server and move the mail server offline or use the mail server for a different task. In order to decommission the mail server, the administrator may set a rule for the mail server in the topology database 214 so that the desired topology 240 of the mail server is to have zero mailboxes.

In the example, when the topology analyzer 242 compares the current state 238 to the desired topology 240, one or more change requests may be generated that move the mailboxes from the soon to be decommissioned mail server to other available mail servers. In some cases, a single change request may be generated that may move all mailboxes in a single operation, while in other cases, separate change requests may be generated for each mailbox.

By modifying the topology definitions in the topology database 214, an administrator may be able to make large changes in the overall email system through the change request 244 generated by the topology analyzer 242, as in the example above. Such changes may be defined by adjustments to the rules or other descriptors of the email system.

In another role, the tracker 232 may provide performance data 246 about the email system. The performance data 246 may be stored in a performance database 248. The performance data 246 may be any measurable parameters that may reflect the performance or ongoing operation of the email system.

From the performance database 248, load data 250 may be derived and analyzed by a load analyzer 252. The load analyzer 252 may be capable of adjusting the mail system by configuring mailboxes across forests or servers based on the amount of traffic, storage space allocations, or other performance parameters. In one use scenario, the load analyzer 252 may be capable of identifying imbalanced load conditions and generating a change request 254 to rectify an imbalance.

For example, one mail server may be servicing a very large number of email messages while another mail server may be servicing a very few number of email message. The load analyzer 252 may receive such data and determine that some of the mailboxes that contribute to the high loads on the first mail server may be moved to the second mail server. The load analyzer 252 may generate one or more change requests that may rectify the imbalanced load situation.

FIG. 3 is a flowchart illustration of an embodiment 300 showing a method for configuring an email system. Embodiment 300 is an example of one method that may be used by an email configuration system, and other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a method where a change request is received, individual steps are defined to implement the change request, and an analysis is performed on each step to test if the step results in a valid configuration. After verifying the steps, the steps are performed. Other embodiments may or may not perform an analysis on each step to verify that the step results in a valid configuration. Some such embodiments may analyze the condition of the mail system after the change is implemented to determine if the change request is valid.

The process may begin in block 302 and a change request may be received in block 304. In some embodiments, the change request may be a single descriptor for a process that may comprise multiple steps. In block 306, the individual steps that may be performed to implement the change request are generated.

For each of the steps in block 308, the step results may be compared to the permissible configuration in block 310. The permissible configuration may be defined in a topology database. If the step results in a permissible configuration in block 312, the process returns to block 308. If the step results in an impermissible configuration in block 312, the step may be flagged as impermissible in block 314, and the process returns to block 308.

If there are failed steps in block 316, the failure may be displayed on a user interface in block 318. A user may be presented with an option to override the failure or fix the failed change request in block 319. If the user elects to override the failure in block 319, the process continues to block 320. If the user elects to fix the change request in block 319, modifications to the change request may be performed in block 312 and the process may continue in block 304. Other embodiments may provide more or different options to a user for dispositioning a failed change request. In some embodiments, automated analysis may be performed on the failed change request to adjust one or more of the individual steps so that a valid configuration is kept throughout the execution of the steps.

For each step in block 320, the step may be performed in block 322 and the step may be stored in an implementation database in block 324. The step may be stored in the implementation database so that the step may be undone at a later time. In such embodiments, various parameters about the system state may be stored along with the step itself so that the undo process may perform properly.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a topology database comprising a topology description for a plurality of mail servers;
a scheduler comprising:
an input queue adapted to receive a change request; and
a change request analyzer adapted to determine that said change request results in a permissible configuration by comparing said change request to said topology database; and
a mailbox configuration tool adapted to implement said change request.

2. The system of claim 1 further comprising:
a topology analyzer adapted to compare said topology description in said topology database to a current configuration and generate at least one change request.

3. The system of claim 1 further comprising:
a user interface adapted to receive said change request.

4. The system of claim 3, said user interface further adapted to display at least a portion of said topology database.

5. The system of claim 1, said topology description comprising mail server specific rules.

6. The system of claim 1, said topology description comprising mailbox specific rules.

7. The system of claim 1 further comprising:
an implementation database adapted to store at least a portion of said change request after said change request is implemented.

8. The system of claim 7, said mailbox configuration tool further adapted to undo said change request using said implementation database.

9. The system of claim 1, said scheduler further comprising:
a task generator adapted to generate a set of individual tasks for said change request.

10. The system of claim 9, said change request analyzer adapted to determine that each of said individual tasks result in a permissible configuration.

11. The system of claim 1 further comprising:
a performance database comprising performance data from said plurality of mail servers.

12. The system of claim 11, said analyzer further adapted to determine that an unbalanced load condition exists and generate said change request, said change request being adapted to change said unbalanced load condition to a balanced load condition.

13. A method comprising:
receiving a change request, said change request comprising a change to a mailbox;
analyzing said change request by a method comprising:
determining a proposed final state from said change request; and
comparing said proposed final state to a topology description of a plurality of mail servers, said topology description being defined in a topology database;
creating a set of actions to be performed in order to fulfill said change request;
storing said set of actions in a change database; and
performing said actions.

14. The method of claim 13 further comprising:
receiving an undo request; and
undoing said change request using said change database.

15. The method of claim 13 further comprising:
determining a current actual topology;
comparing said current actual topology to said topology database to identify an impermissible condition; and
generating said change request adapted to change said impermissible condition to a permissible condition.

16. The method of claim 13 further comprising:
searching a network to discover a new mail server; and
adding said new mail server to said topology database.

17. The method of claim 13 further comprising:
analyzing a performance database and said topology description to determine that a load imbalance condition exists; and
generating said change request adapted to change said load imbalance condition to a balanced load condition.

18. The method of claim 13, said topology description comprising mail server specific rules.

19. The method of claim 13, said topology description comprising mailbox specific rules.

20. A computer readable medium comprising computer executable instructions adapted to perform the method of claim 1.
